(19) United States
(12) Patent Application Publication
(10) Pub. No.: US 2018/0150654 A1
(43) Pub. Date: May 31, 2018

(54) Techniques for a Field Programmable Gate Array to Perform a Function for an Application Specific Integrated Circuit

(71) Applicant: Intel Corporation, Santa Clara, CA (US)

(72) Inventors: Patrick Connor, Beaverton, OR (US); Scott P. Dubal, Beaverton, OR (US); Sridhar Samudrala, Beaverton, OR (US); Praveen Mala, Hillsboro, OR (US); Sibai Li, Portland, OR (US)

(73) Assignee: Intel Corporation, Santa Clara, CA (US)

(21) Appl. No.: 15/365,119

(22) Filed: Nov. 30, 2016

(51) Int. Cl. G06F 21/76; H04L 9/06

(52) U.S. Cl. CPC G06F 21/76; H04L 2209/12; H04L 9/0631

(57) ABSTRACT

Examples include techniques for a field programmable gate array (FPGA) to perform one or more functions for an application specific integrated circuit (ASIC). Example techniques include communication between the ASIC and the FPGA via a sideband communication link to enable the ASIC to indicate to the FPGA a need for the FPGA to perform a function to fulfill a request received by the ASIC.

### TECHNICAL FIELD

Examples described herein are generally related to an application specific integrated circuit (ASIC) coupled with a Field Programmable Gate Array (FPGA) for performing one or more functions.

### BACKGROUND

Specialized integrated circuits such as ASICS may be programmed with relatively unknown or complex programming languages and may have fixed or rigid functionality. For example, a specialized ASIC may be configured as a content processing module (CPM) having a cryptographic and packet processing engine associated with Intel® QuickAssist Technology (QAT). The specialized ASIC having a cryptographic engine associated with QAT may be programmed using a programming language that may be known by relatively few programmers and once programmed may have a fixed or rigid functionality. Other types of specialized ASICs programmed with relatively unknown or complex programming languages may include, but are not limited to, specialized ASICs used to support network interface cards (NICs) having switch capabilities or specialized ASICs used to support packet schedulers for Ethernet-based data packets.

### BRIEF DESCRIPTION OF THE DRAWINGS

FIG. 1 illustrates an example first system.

FIG. 2 illustrates example second system.

FIG. 3 illustrates an example first logic flow.

FIG. 4 illustrates an example block diagram for a first apparatus.

FIG. 5 illustrates an example of a second logic flow.

FIG. 6 illustrates an example of a first storage medium.

FIG. 7 illustrates an example block diagram for a second apparatus.

FIG. 8 illustrates an example of a third logic flow.

FIG. 9 illustrates an example of a second storage medium.

FIG. 10 illustrates an example computing platform.

### DETAILED DESCRIPTION

As contemplated in the present disclosure, specialized ASICs such as those having a cryptographic engine, such as one associated with QAT, those supporting NICs with switching capabilities or those supporting packet schedulers may be programmed with relatively unknown or complex programming languages and once programmed may have fixed or rigid functionality. These relatively unknown or complex programming languages and the fixed or rigid functionality may make it difficult to update or timely adapt these specialized ASICs to meet changing operating environments. For example, a specialized ASIC having a cryptographic engine associated with QAT may be tasked with encrypting or decrypting content using a cryptographic algorithm that the specialized ASIC has not been programmed to handle, e.g., a new advanced encryption standard (AES) algorithm. Timely updating or adapting this specialized ASIC to handle the new AES algorithm may be problematic given its inherent fixed or rigid functionality. It is with respect to these challenges that the examples described herein are needed.

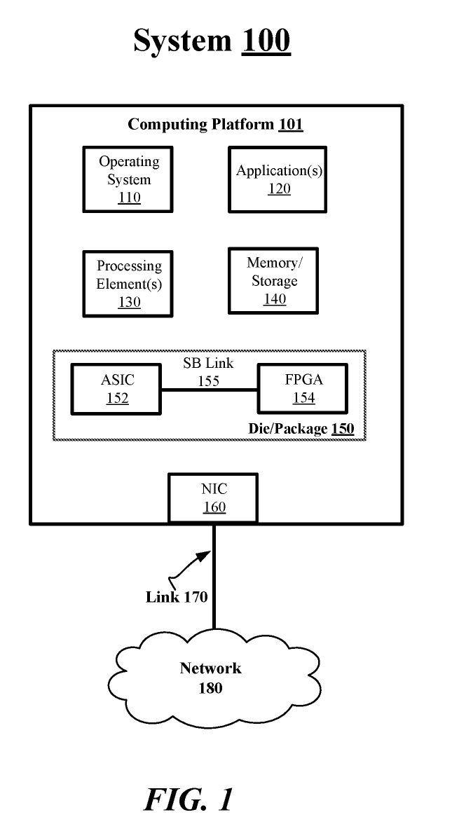

FIG. 1 illustrates an example system 100. In some examples, as shown in FIG. 1, system 100 includes a computing platform 101 having an operating system 110, one or more application(s) 120, one or more processing element(s) 130, a memory/storage 140, a die/package 150 or a network interface card (NIC) 160. For these examples, as shown in FIG. 1, computing platform 101 may couple to a network 180 via a link 170 through NIC 160.

According to a first example, as shown in FIG. 1, die/package 150 includes an ASIC 152 and a field programmable gate array (FPGA) 154 coupled together via a sideband (SB) link 155. For these examples, ASIC 152, FPGA 154 and SB link 155 may either be maintained on a single die or may be separate dies included in a single package while being a part of die/package 150. Although not shown in FIG. 1, in a second example, ASIC 152 and FPGA 154 may be maintained on separate dies not included in a single package but still coupled via SB link 155.

In some examples, ASIC 152 may be configured as a type of specialized ASIC such as a cryptographic engine. For these examples, ASIC 152 may be configured as type of cryptographic accelerator or offload engine supporting processing element(s) 130 and/or other elements of computing platform 101. In other examples, ASIC 152 may be configured as another type of specialized ASIC to support NIC 160. For these other examples, ASIC 152 may be configured as offload engine to facilitate switching functions or packet scheduling functions for NIC 160 for routing/forwarding data packets to destinations at computing platform 101 or routing/forwarding to or from destinations accessible via network 180 via link 170.

According to some examples, ASIC 152 may be programmed using a proprietary-based or specialized, relatively unknown or complex programming language. Meanwhile, FPGA 154 may be programmed using a relatively commonly known programming language that may include, but is not limited to, Verilog or very high speed integrated circuit (VHSIC) hardware description language (VHDL). If programmed using VHDL, FPGA 154 may be programmed in accordance with one or more industry standards promulgated by the Institute of Electrical and Electronics Engineers (IEEE) such as IEEE 1076-2008, VHDL Language Reference Manual, published in January 2009 (hereinafter “VHDL-2008”). If programmed using Verilog, FPGA 154 may be programmed in accordance with one or more other industry standards promulgated by the IEEE such as IEEE 1800-2012, SystemVerilog—Unified Hardware Design, Specification, and Verification Language, published in February 2013 (hereinafter “SystemVerilog”).

In some examples, ASIC 152 may be programmed using a proprietary/specialized programming language to handle specific tasks in support of elements of computing platform 101 such as processing element(s) 130 and/or NIC 160. For example, programmed to use or capable of knowing a specific number of AES algorithms or other types of cryptographic algorithms for encrypting or decrypting data, programmed to use or capable of knowing a specific number of forwarding tables for routing data packets or programmed to use or capable of knowing a specific number of scheduling rules for schedule routing of data packets. However, in some examples, ASIC 152 may receive a request that may not be met using its existing programming or capabilities. For these examples, ASIC 152 may be capable of communicating with FPGA 154 via SB link 155 to let FPGA 154 know it lacks the programming and/or capabilities to meet the request. As described more below, FPGA 154 may include logic and/or features capable of enabling FPGA 154 to meet the request. For example, the logic and/or features may update cryptographic algorithms, update forwarding tables or update scheduling rules available or known to FPGA 154. The pairing of a relatively easy to program FPGA 154 with a relatively hard to program ASIC 152 may facilitate additional programming of FPGA 154, when needed and thus expand capabilities for this ASIC/FPGA combination to perform one or more functions to meet or fulfill the request.

According to some examples, computing platform 101 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

In some examples, processor element(s) 130 may include various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon® or Xeon Phi® processors; and similar processors.

According to some examples, memory/storage 140 may be composed of one or more memory devices or dies which may include various types of volatile and/or non-volatile memory arranged as either system memory, as a storage or a combination of memory/storage. Volatile memory may include, but is not limited to, random-access memory (RAM), Dynamic RAM (DRAM), double data rate synchronous dynamic RAM (DDR SDRAM), static random-access memory (SRAM), thyristor RAM (T-RAM) or zero-capacitor RAM (Z-RAM). Non-volatile memory may include, but is not limited to, non-volatile types of memory such as 3-dimensional (3-D) cross-point memory that may be byte or block addressable. These block addressable or byte addressable non-volatile types of memory may include, but are not limited to, memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), a combination of any of the above, or other non-volatile memory types.

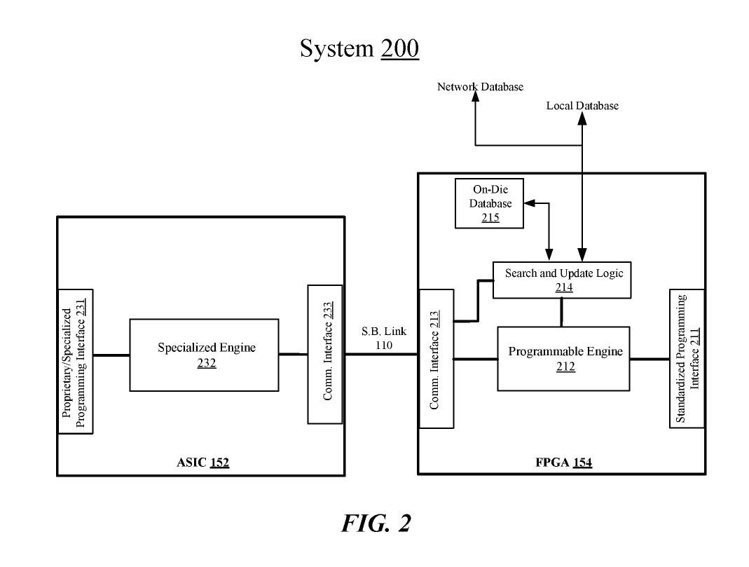

FIG. 2 illustrates example system 200. In some examples, as shown in FIG. 2, system 200 may include ASIC 152 coupled with FPGA 154 via SB link 155. For these examples, ASIC 152 may include a specialized engine 232 that may be circuitry arranged to handle specific tasks based on programming received via a proprietary/specialized programming interface 231. ASIC 152 may also include a communication interface 233 coupled to SB link 155. According to some examples, FPGA 154 may include logic and/or features such as search and update logic 214 that may be capable of receiving a sideband message that includes information that indicates ASIC 152 is not programmed or capable to perform a function (e.g., included in a request received by ASIC 152 and updating or programming a programmable engine 212 of FPGA 154 if programmable engine 212 lacks programming or the capability to perform the function. Also, FPGA 154 may be programmed via a standardized programming interface 211 using a standardized and/or commonly known programming language such as, but not limited to, Verilog (e.g., according to SystemVerilog) or VHDL (e.g., according to VHDL-2008).

According to some examples, specialized engine 232 may include circuitry, logic and/or features capable of recognizing that it lacks the programming or capability needed to meet a request and to notify FPGA 154 via a sideband message routed via SB link 155 of this lack of programming or capability. For these examples, SB link 155 may be considered a secondary, sideband or out of band communication link as ASIC 152 may be receiving and responding to the request from a primary or in-band communication link maintained with processing element(s) 130, NIC 160 and/or other elements of computing platform 101. The primary or in-band communication link may be arranged to operate using communication protocols and/or communication interfaces compliant with such standards as the Peripheral Component Interconnect (PCI) Express Base Specification, revision 3.1a, published in December 2015 (“PCI Express specification” or “PCIe specification”). Examples are not limited to communication protocols and/or communication interfaces compliant with the PCIe specification.

In some examples, communication interfaces 213 and 233 as well as SB link 155 may be arranged to provide a communication link that is considered secondary, sideband or out of band relative to the primary or in-band communication link maintained with processing element(s) 130, NIC 160 and/or other elements of computing platform 101. For these examples, communication interfaces 213 and 233 as well as SB link 155 may be arranged to communicate via a serial data bus using communication protocols and/or communication interfaces compliant with such standards as the PCIe specification and/or using communication protocols and/or communication interfaces according to other standards or specifications such as those associated with system management bus (SMBus) or integrated-to-integrate circuit (I²C).

In some examples, responsive to a sideband message from ASIC 152 indicating a lack of programming or capability to perform a function and if FPGA 154 also lacks the programming or capability to perform the function, circuitry, logic and/or features of search and update logic 214 may be capable of first searching an on-die database such as on-die database 215 for needed information (e.g., a given AES algorithm) to enable the programming of programmable engine 212 to remedy programmable engine 212's inability to perform the function to meet the request. If a search of the on-die database was unable to find the needed information, logic and/or features of search and update logic 214 may be capable of searching a local database (e.g., maintained in memory/storage 140) or searching a network database (e.g., accessible via network 180). In alternative examples, an external agent to FPGA 154 (e.g., software or firmware) could also work with logic and/or features of search and update logic 212 to enable the programming of programmable engine 212 to perform the function to meet the request. These external agents (not shown) may assist in a search for the needed information in either local or network databases or may even assist in updating the programming of programmable engine 212.

In some examples, on-die database 215 may include non-volatile types of memory to maintain data that may only be modified or updated responsive to programming through standardized programming interface 211. In other examples, the data may also be modified or updated responsive to search and update logic 214 obtaining information from local and/or network database responsive to a sideband message from ASIC 152. According to some examples, the non-volatile types of memory included in on-die database 215 may include, but is not limited to, 3-D cross-point memory, multi-threshold level NAND flash memory, NOR flash memory, single or multi-level PCM, resistive memory, nanowire memory, FeTRAM, MRAM that incorporates memristor technology, STT-MRAM, a combination of any of the above, or other non-volatile memory types.

According to some examples, ASIC 152 may be configured as a type of specialized ASIC to support a NIC such as NIC 160. For these examples, specialized engine 232 may be programmed or capable of functioning as an offload engine to facilitate switching functions or packet scheduling functions for the NIC. ASIC 152 may have a need to have a near real time update due to security threat such as a distributed denial-of-service (DDoS) attack that may require the near real time update to restrict network access when these types of security threats are detected. The restrictions may not have been previously programmed to ASIC 152 or FPGA 154. Logic and/or features of specialized engine 232 may initiate a process with logic and/or features of search and update logic 214 to enable programmable engine 212 to be quickly informed of the need to adapt to these new network access restrictions based on ASIC 152 receiving a request to implement restrictions it does not recognize or is not programmed to perform. Also, in some examples where ASIC 152 may be configured to support a NIC, ASIC 152 may be designed to perform packet parsing for image data and examining the image data for objects and/or faces. For these examples, if programmable engine 212 encounters objects and/or faces it was not programmed to recognize or if updates to objects and/or faces are needed, logic and/or features of specialized engine 232 may initiate a similar process as mentioned above to enable programmable engine 212 to be quickly informed of the need to adapt recognition algorithms to recognize new objects and/or faces.

In some examples, ASIC 152 may be configured as a type of specialized ASIC such as those having a cryptographic engine associated with QAT. For these examples, specialized engine 232 may be programmed or capable of handling a specific number of cryptographic algorithms to encrypt or decrypt data or content. For example, a specific number of AES algorithms or other types of cryptographic algorithms. However, in some examples, ASIC 152 may receive a request to encrypt or decrypt data or content using a new AES algorithm not recognized by specialized engine 232. Logic and/or features of specialized engine 232 may initiate a process with logic and/or features of search and update logic 214 to enable programmable engine 212 of FPGA 154 to adapt to this new AES algorithm in order to fulfill requests for encrypting or decrypting data or content using the new AES algorithm.

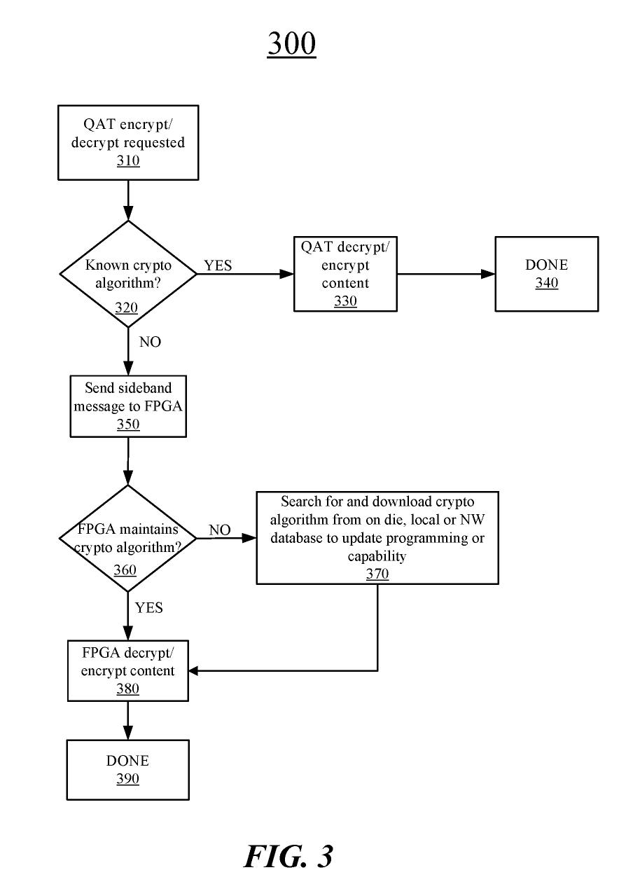

FIG. 3 illustrates an example logic flow 300. In some examples, at least portions of logic flow 300 may be implemented by logic and/or features at an ASIC such as logic and/or features of specialized engine 232 of ASIC 152 of system 200 shown in FIG. 2. For these examples, specialized engine 232 may be programmed as a cryptographic accelerator or offload engine associated with Intel QAT. Portions of logic flow 300 may also be implemented by logic and/or features at an FPGA such as logic and/or features of search and update logic 214 or programmable engine 212 of FPGA 154 of system 200 shown in FIG. 2. However, logic flow 300 is not limited to being implemented by logic and/or features at an ASIC or FPGA such as ASIC 152 or FPGA 154 shown in FIG. 2.

Beginning at block 310, logic and/or features of ASIC 152 may receive a request (e.g., from elements of computing platform 101 such as processing element(s) 130) for encryption or decryption of content or data by specialized engine 232. The request, for example, may include information indicating a particular cryptographic algorithm to use such as, but not limited to, AES algorithms, data encryption standard (DES) algorithms, Rivest Cipher 4 (RC4) algorithms or secure hash algorithms (SHA, SHA-1, SHA-2 or SHA-3).

At decision block 320, logic and/or features of ASIC 152 may determine whether specialized engine 232 knows the cryptographic algorithm indicated in the request or has been programmed to encrypt or decrypt the content or data using the cryptographic algorithm. For example, determine whether the cryptographic algorithm is maintained in an ASIC data structure such as a lookup table (LUT). The logic flow may then move to block 330 if the cryptographic algorithm is known or programmed into specialized engine 232. Otherwise, the logic flow 300 moves to block 350.

At block 330, specialized engine 232 may decrypt/encrypt the content or data using the known cryptographic algorithm.

At block 340, logic flow 300 is done. In some examples, being done may include ASIC 152 providing the encrypted/decrypted content or data to the requestor.

At block 350, logic and/or features of ASIC 152 may send a sideband message to FPGA 154. According to some examples, the sideband message may be sent via SB link 155 and may include an indication that ASIC 152 lacks the programming or capability to fulfill an encrypt/decrypt request. For these examples, the sideband message may also include information to indicate the unknown cryptographic algorithm.

At decision block 360, logic and/or features of FPGA 154 may receive the sideband message and make a determination of whether the cryptographic algorithm that is unknown by ASIC 152 is programmed to or known by programmable engine 212 at FPGA 154. 4. If the cryptographic algorithm is not programmed to or known by programmable engine 212, logic flow 300 moves to block 370. Otherwise, logic flow 300 moves to block 380.

At block 370, logic and/or features of search and update logic 214 of FPGA 154 may search for and then download or retrieve the cryptographic algorithm from either an on die database, a local or network database to update programming or capability of FPGA 154 to fulfill the request to perform the function. The on die database may be maintained in on die database 215. The local database may be maintained at memory/storage 140. The network database may be accessible at network 180 via link 170.

At block 380, logic and/or features of programmable engine 212 may decrypt/encrypt content to fulfill the encrypt/decrypt request.

At block 390, logic flow 300 is done. In some examples, being done may include FPGA 154 providing the encrypted/decrypted content or data to the requestor.

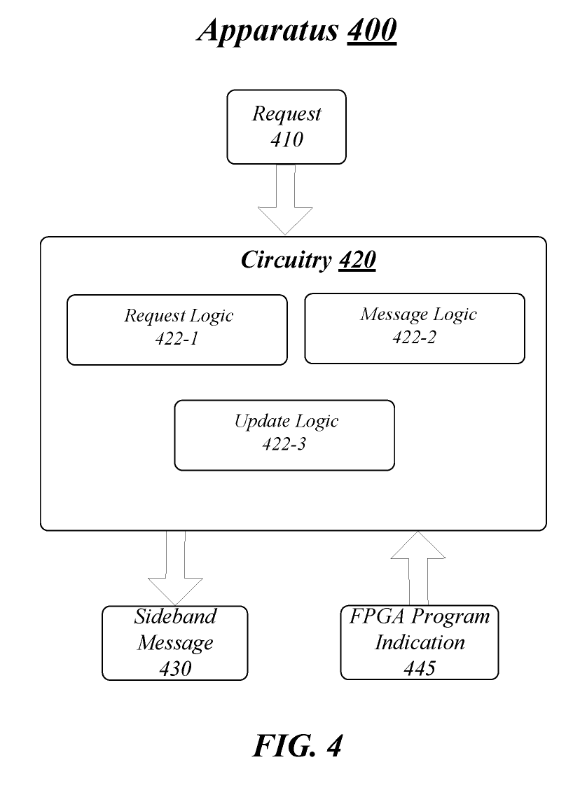

FIG. 4 illustrates an example block diagram for apparatus 400. Although apparatus 400 shown in FIG. 4 has a limited number of elements in a certain topology, it may be appreciated that the apparatus 400 may include more or less elements in alternate topologies as desired for a given implementation.

According to some examples, apparatus 400 may be included in an ASIC such as ASIC 152 shown in FIGS. 1 and 2 and may be supported by circuitry 420 maintained at the ASIC. The ASIC may be coupled with an FPGA via a sideband communication link such as FPGA 154 shown in FIGS. 1 and 2. Circuitry 420 may be include one or more modules, components or logic 422-a (module, component or logic may be used interchangeably in this context). It is worthy to note that “a” and “b” and “c” and similar designators as used herein are intended to be variables representing any positive integer. Thus, for example, if an implementation sets a value for a=3, then a complete set of modules, components or logic 422-a may include logic 422-1, 422-2 or 422-3. The examples presented are not limited in this context and the different variables used throughout may represent the same or different integer values. Also, “logic” may also include software/firmware stored in computer-readable media, and although logic is shown in FIG. 4 as discrete boxes, this does not limit this logic to storage in distinct computer-readable media components (e.g., a separate memory, etc.).

According to some examples, circuitry 420 may include a processor, processor circuit or processor circuitry. Circuitry 420 may be generally arranged to execute one or more software components 422-a. Circuitry 420 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. In some examples, as mentioned above, circuitry 420 may be included in the ASIC that includes apparatus 400. For these examples, at least some modules, components or logic 722-a may be implemented as hardware elements of the ASIC.

According to some examples, circuitry 420 may include a request logic 422-1. Request logic 422-1 may receive a request to perform a function for which the ASIC that includes apparatus 400 is not programmed or capable to perform. For these examples, the request may be included in request 410 and depending on what types of function ASIC may be capable of performing (if programmed) may include, but are not limited to, encrypt/decrypt data, data packet routing via use of destination address (e.g., based on a forwarding information base (FIB) or forwarding table) or implement one or more scheduling rules to route one or more packets to one or more destinations (e.g., based on one or more routing tables). The ASIC may be considered as not programmed or capable to perform the function if a given algorithm is unknown for an encrypt/decrypt function, if a given destination address is unknown for a data packet routing function or if a given scheduling rule is unknown for implementing schedule rules function.

In some examples, circuitry 420 may include a message logic 422-2. Message logic 422-2 may send a sideband message via the sideband communication link coupled between the ASIC and the FPGA. For these examples, the sideband message may be included in sideband message 430 and may include information that indicates the ASIC is not programmed or capable to perform the function to fulfill the request and may also indicate what the ASIC may lack in order to fulfill the request (e.g., lacks a new cryptographic algorithm).

According to some examples, circuitry 420 may also include an update logic 422-3. Update logic 422-3 may receive an indication via the sideband communication link to indicate the FPGA has been programmed or is capable to perform the function to fulfill the request. For these examples, the indication may be included in FPGA program indication 445.

Various logic, modules or components of apparatus 400 may be communicatively coupled to each other by various types of communications media to coordinate operations. The coordination may involve the uni-directional or bi-directional exchange of information. For instance, the logic, modules or components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

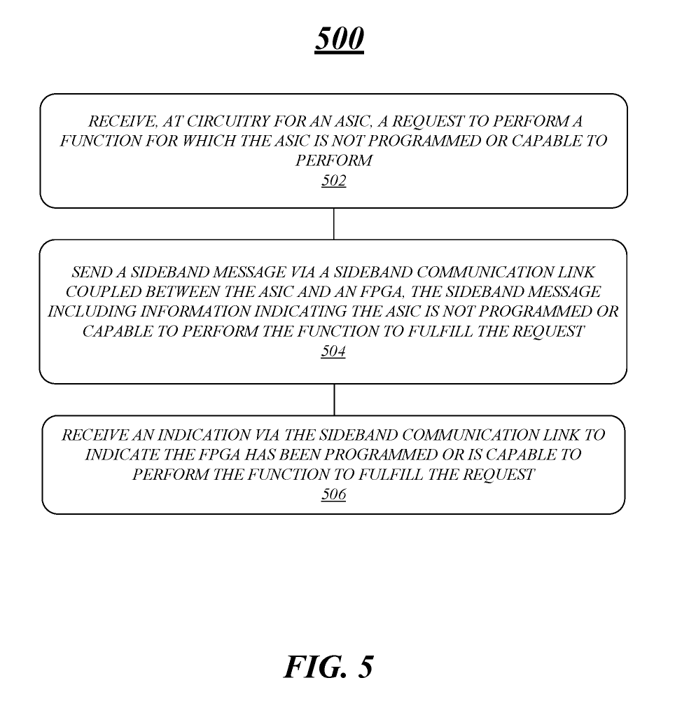

FIG. 5 illustrates an example logic flow 500. Logic flow 500 may be representative of some or all of the operations executed by one or more logic, features, or devices described herein, such as apparatus 400. More particularly, logic flow 500 may be implemented by at least receive logic 422-1, message logic 422-2 or update logic 422-3.

According to some examples, logic flow 500 at block 502 may receive, at circuitry for an ASIC, a request to perform a function for which the ASIC is not programmed or capable to perform. For these examples, receive logic 422-1 may receive the indication.

In some examples, logic flow 500 at block 504 may send a sideband message via a sideband communication link coupled between the ASIC and an FPGA, the sideband message to include information that indicates the ASIC is not programmed or capable to perform the function to fulfill the request. For these examples, message logic 422-2 may send the sideband message.

According to some examples, logic flow 500 at block 506 may receive an indication via the sideband communication link to indicate the FPGA has been programmed or is capable to perform the function to fulfill the request. For these examples, update logic 422-3 may receive the indication.

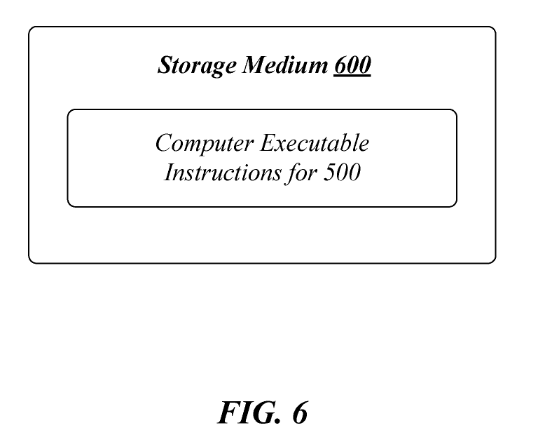

FIG. 6 illustrates an example storage medium 600. As shown in FIG. 6, the first storage medium includes a storage medium 600. The storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

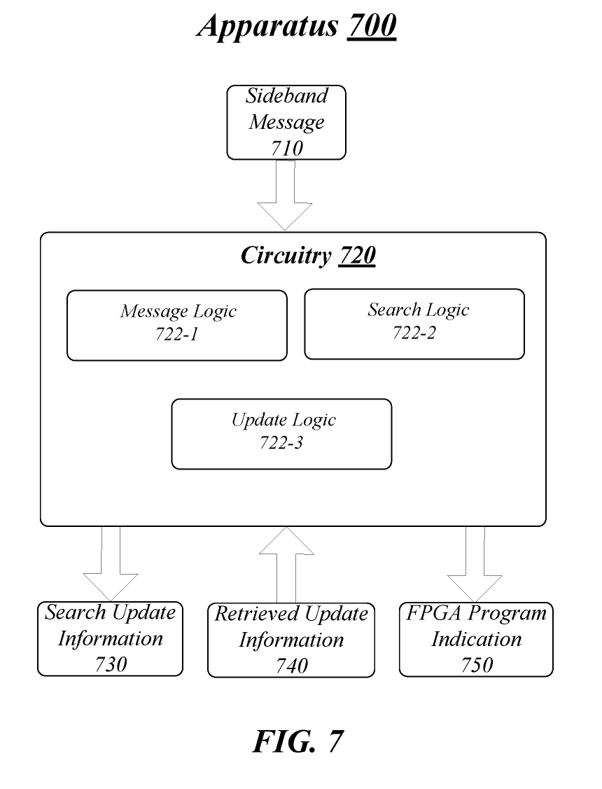

FIG. 7 illustrates an example block diagram for apparatus 700. Although apparatus 700 shown in FIG. 7 has a limited number of elements in a certain topology, it may be appreciated that the apparatus 700 may include more or less elements in alternate topologies as desired for a given implementation.

According to some examples, apparatus 700 may be included in an FPGA such as FPGA 154 shown in FIGS. 1 and 2 and may be supported by circuitry 720 maintained at the FPGA. The FPGA may be coupled with an ASIC via a sideband communication link such as ASIC 152 shown in FIGS. 1 and 2. Circuitry 720 may include one or more modules, components or logic 722-a (module, component or logic may be used interchangeably in this context). It is worthy to note that “a” and “b” and “c” and similar designators as used herein are intended to be variables representing any positive integer. Thus, for example, if an implementation sets a value for a=3, then a complete set of modules, components or logic 722-a may include logic 722-1, 722-2 or 722-3. The examples are not limited in this context and the different variables used throughout may represent the same or different integer values. Also, “logic” may also include software/firmware stored in computer-readable media, and although logic is shown in FIG. 7 as discrete boxes, this does not limit this logic to storage in distinct computer-readable media components (e.g., a separate memory, etc.).

According to some examples, circuitry 720 may include a processor, processor circuit or processor circuitry. Circuitry 720 may be generally arranged to execute one or more software components 722-a. Circuitry 720 can be any of various commercially available processors to include but not limited to the processors mentioned above for apparatus 400. In some examples, as mentioned above, circuitry 720 may be included in the FPGA that includes apparatus 700. For these examples, at least some modules, components or logic 722-a may be implemented as hardware elements of the FPGA.

According to some examples, circuitry 720 may include a message logic 722-1. Message logic 722-1 may receive a sideband message from the sideband communication link coupled between the FPGA and ASIC. For these examples, the sideband message may be included in sideband message 710 and may include information that indicates the ASIC lacks programming or a capability to fulfill a request to perform a function.

In some examples, circuitry 720 may include a search logic 722-2. Search logic 722-2 may search for and retrieve update information to update programming or capability of the FPGA to fulfill the request to perform the function if the FPGA lacks programming or capability to perform the function. For these examples, search logic 722-2 may use search update information 730 (e.g., search criteria for a given cryptographic algorithm) to search an on-die database maintained at the FPGA, search a local database maintained at a computing platform hosting the ASIC and the FPGA or search a network database coupled with the computing platform through a network. Search logic 722-2 may then retrieve updated information included in retrieved update information 740 from the on-die database, the local database or the network database. In some alternative examples, search logic 722-2 may communicate with an agent external to the FPGA (e.g., located or executed by one or more processing elements for the computing platform) to request that the external agent retrieve and provide update information 740 using search update information 730.

According to some examples, circuitry 720 may also include update logic 722-3. Update logic 722-3 may send an indication via the sideband communication link to the ASIC to indicate the FPGA is programmed or capable to perform the function to fulfill the request. For these examples, FPGA program indication 750 may include the indication sent to the ASIC via the sideband communication link.

Various logic, modules or components of apparatus 700 may be communicatively coupled to each other by various types of communications media to coordinate operations. The coordination may involve the uni-directional or bi-directional exchange of information. For instance, the logic, modules or components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

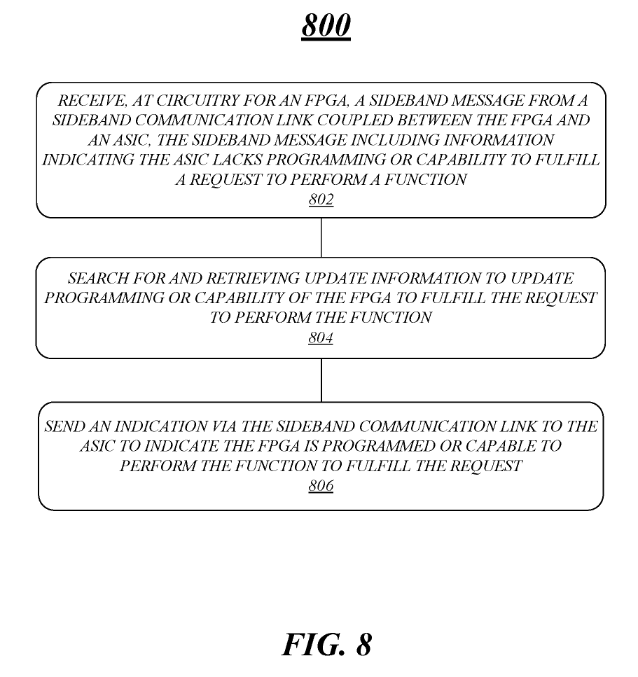

FIG. 8 illustrates an example logic flow 800. Logic flow 800 may be representative of some or all of the operations executed by one or more logic, features, or devices described herein, such as apparatus 700. More particularly, logic flow 800 may be implemented by at least message logic 722-1, search logic 722-2 or update logic 722-3.

According to some examples, logic flow 800 at block 802 may receive, at circuitry for an FPGA, a sideband message from a sideband communication link coupled between the FPGA and an ASIC, the sideband message to include information that indicates the ASIC lacks programming or capability to fulfill a request to perform a function. For these examples, message logic 722-1 may receive the sideband message.

In some examples, logic flow 800 at block 804 may search for and retrieve update information to update programming or capability of the FPGA to fulfill the request to perform the function. For these examples, search logic 722-2 may search for and retrieve the update information.

According to some examples, logic flow 800 at block 806 may send an indication via the sideband communication link to the ASIC to indicate the FPGA is programmed or capable perform the function to fulfill the request. For these examples, update logic 722-3 may send the indication.

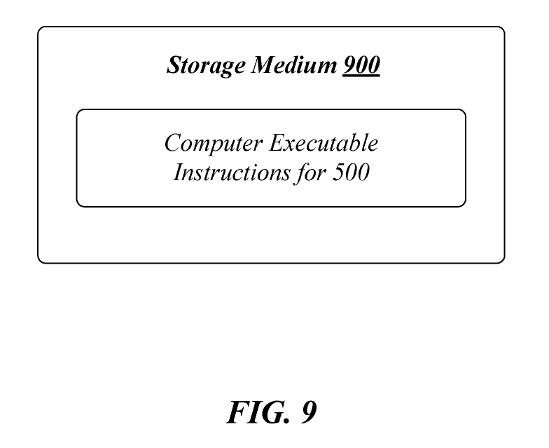

FIG. 9 illustrates an example storage medium 900. As shown in FIG. 9, the first storage medium includes a storage medium 900. The storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions to implement logic flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

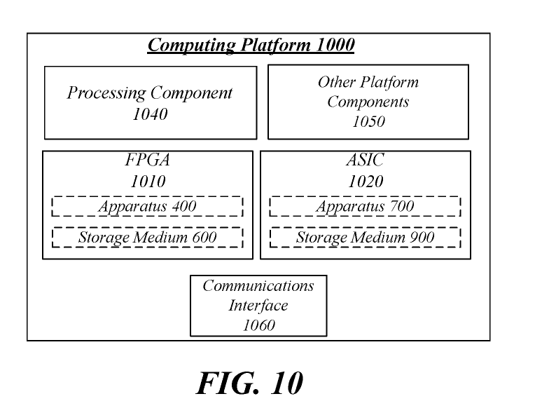

FIG. 10 illustrates an example computing platform 1000. In some examples, as shown in FIG. 10, computing platform 1000 may include an FPGA 1010, an ASIC 1020, a processing component 1040, other platform components 1050 or a communications interface 1060.

In some examples, FPGA 1010 may include circuitry to execute processing operations or logic for apparatus 400 and/or storage medium 600. FPGA 1010 may be hosted by computing platform 1000 and may be arranged to operate in a similar manner to FPGA 154 shown in FIGS. 1 and 2. Although not shown in FIG. 10, FPGA 1010 may be coupled with ASIC 1020 via a sideband communication link. FPGA 1010 may include various hardware elements, software elements, or a combination of both. Examples of hardware elements may include logic devices, components, processor circuits, circuit elements (e.g., transistors, resistors, capacitors, inductors, and so forth), integrated circuits, programmable logic devices (PLDs), digital signal processors (DSPs), memory units, logic gates, registers and so forth. Examples of software elements may include instruction sets, computing code, computer code, code segments, computer code segments, words, values, symbols, or any combination thereof.

According to some examples, ASIC 1020 may include circuitry to execute processing operations or logic for apparatus 700 and/or storage medium 900. ASIC 1020 may also be hosted by computing platform and may be arranged to operate in a similar manner to ASIC 152 shown in FIGS. 1 and 2. ASIC 1020 may include various hardware elements, software elements, or a combination of both. Examples of hardware and software elements may be similar to but are not limited to the hardware and software elements mentioned above for FPGA 1010.

According to some examples, processing component 1040 may execute processing operations or logic for elements of computing platform 1000 such as an operating system and one or more applications (not shown). Processing component 1040 may include various hardware elements, software elements, or a combination of both. Examples of hardware elements may include devices, logic devices, components, processors, microprocessors, circuits, processor circuits, circuit elements, integrated circuits, ASIC (separate from ASIC 1020), PLDs, DSPs, FPGA (separate from FPGA 1010), memory units, storage units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

According to some examples, for FPGA 1010, ASIC 1020 or processing component 1040, determining whether an example is implemented using hardware elements and/or software elements may vary in accordance with any number of factors. The any number of factors may include, but are not limited to, desired computational rate, power levels, heat tolerances, processing cycle budget, input data rates, output data rates, memory resources, data bus speeds and other design or performance constraints, as desired for a given example.

In some examples, other platform components 1050 may include common computing elements, memory units, chipsets, controllers, peripherals, interfaces, oscillators, timing devices, video cards, audio cards, multimedia input/output (I/O) components (e.g., digital displays), power supplies, and so forth. Examples of memory units or memory devices may include without limitation various types of computer readable and machine readable storage media in the form of one or more higher speed memory units, such as read-only memory (ROM), RAM, DRAM, DDR SRAM), SRAM, programmable ROM (PROM), erasable programmable ROM (EPROM), electrically erasable programmable ROM (EEPROM), flash memory, multi-threshold level NAND flash memory, polymer memory such as ferroelectric polymer memory, ovonic memory, phase change or ferroelectric memory, 3-D cross-point memory, FeTRAM, MRAM, STT-MRAM, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1060 may include logic and/or features to support a communication interface. For these examples, communications interface 1060 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by the Institute of Electrical and Electronics Engineers (IEEE). For example, one such Ethernet standard promulgated by IEEE may include IEEE 802.3-2012, Carrier sense Multiple access with Collision Detection (CSMA/CD) Access Method and Physical Layer Specifications, Published in December 2012 (hereinafter “IEEE 802.3 specification”). Network communication may also occur according to one or more OpenFlow specifications such as the OpenFlow Hardware Abstraction API Specification. Network communications may also occur according to Infiniband Architecture specification.

Computing platform 1000 may be implemented in a server or client computing device. Accordingly, functions and/or specific configurations of computing platform 1000 described herein, may be included or omitted in various embodiments of computing platform 1000, as suitably desired for a server or client computing device.

The components and features of computing platform 1000 may be implemented using any combination of discrete circuitry, ASICs, logic gates and/or single chip architectures. Further, the features of computing platform 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The follow examples pertain to additional examples of technologies disclosed herein.

### Example 1

An example apparatus may include circuitry at an ASIC. The circuitry may include request logic to receive a request to perform a function for which the ASIC is not programmed or capable to perform. The circuitry may also include message logic for execution by the circuitry to send a sideband message via a sideband communication link coupled between the ASIC and an FPGA. The sideband message may include information that indicates the ASIC is not programmed or capable to perform the function to fulfill the request. The circuitry may also include update logic for execution by the circuitry to receive an indication via the sideband communication link to indicate the FPGA has been programmed or is capable to perform the function to fulfill the request.

### Example 2

The apparatus of example 1, the function may be encrypting or decrypting data via use of a cryptographic algorithm specified in the request.

### Example 3

The apparatus of example 2, the information to indicate the ASIC is not programmed or capable to perform the function to fulfill the request may include the information to also indicate the cryptographic algorithm is unknown to the ASIC.

### Example 4

The apparatus of example 1, the function may be data packet routing via use of a given destination address.

### Example 5

The apparatus of example 4, the information to indicate the ASIC is not programmed or capable to perform the function to fulfill the request may include the information to also indicate the given destination address is unknown to the ASIC.

### Example 6

The apparatus of example 1, the function comprises implementation of a given scheduling rule to route one or more data packets to one or more destinations.

### Example 7

The apparatus of example 6, the information to indicate the ASIC is not programmed or capable to perform the function to fulfill the request may include the information to indicate the given scheduling rule is unknown to the ASIC.

### Example 8

The apparatus of example 1, the ASIC and the FPGA may be maintained or located on a same die or a same die package.

### Example 9

An example method may include receiving, at circuitry for an ASIC, a request to perform a function for which the ASIC is not programmed or capable to perform. The method may also include sending a sideband message via a sideband communication link coupled between the ASIC and an FPGA. The sideband message may include information indicating the ASIC is not programmed or capable to perform the function to fulfill the request. The method may also include receiving an indication via the sideband communication link to indicate the FPGA has been programmed or is capable to perform the function to fulfill the request.

### Example 10

The method of example 9, the function may include encrypting or decrypting data using a cryptographic algorithm specified in the request.

### Example 11

The method of example 10, the information indicating the ASIC is not programmed or capable to perform the function to fulfill the request may include the information also indicating the cryptographic algorithm is unknown to the ASIC.

### Example 12

The method of example 9, the function may include data packet routing using a given destination address.

### Example 13

The method of example 12, the information indicating the ASIC is not programmed or capable to perform the function to fulfill the request may include the information also indicating the given destination address is unknown to the ASIC.

### Example 14

The method of example 910, the function may include implementing a given scheduling rule to route one or more data packets to one or more destinations.

### Example 15

The method of example 14, the information indicating the ASIC is not programmed or capable to perform the function to fulfill the request may include the information also indicating the given scheduling rule is unknown to the ASIC.

### Example 16

The method of example 9, the ASIC and the FPGA may be maintained or located on a same die or a same die package.

### Example 17

An example at least one machine readable medium may include a plurality of instructions that in response to being executed by a system may cause the system to carry out a method according to any one of examples 9 to 16.

### Example 18

An example apparatus may include means for performing the methods of any one of examples 9 to 16.

### Example 19

At least one machine readable medium may include a plurality of instructions that in response to being executed by a system at an ASIC may cause the system to receive a request to perform a function for which the ASIC is not programmed or capable to perform. The instructions may also cause the system to send a sideband message via a sideband communication link coupled between the ASIC and an FPGA. The sideband message may include information that indicates the ASIC is not programmed or capable to perform the function to fulfill the request. The instructions may also cause the system to receive an indication via the sideband communication link to indicate the FPGA has been programmed or is capable to perform the function to fulfill the request.

### Example 20

The at least one machine readable medium of example 19, the function may include encrypting or decrypting data via use of a cryptographic algorithm specified in the request.

### Example 21

The at least one machine readable medium of example 20, the information to indicate the ASIC is not programmed or capable to perform the function to fulfill the request may include the information to also indicate the cryptographic algorithm is unknown to the ASIC.

### Example 22

The at least one machine readable medium of example 19, the function may include data packet routing via use of a given destination address.

### Example 23

The at least one machine readable medium of example 22, the information to indicate the ASIC is not programmed or capable to perform the function to fulfill the request may include the information to also indicate the given destination address is unknown to the ASIC.

### Example 24

The at least one machine readable medium of example 19, the function may include implementation of a given scheduling rule to route one or more data packets to one or more destinations.

### Example 25

The at least one machine readable medium of example 246, the information to indicate the ASIC is not programmed or capable to perform the function to fulfill the request may include the information to also indicate the given scheduling rule is unknown to the ASIC.

### Example 26

The at least one machine readable medium of example 19, the ASIC and the FPGA may be maintained or located on a same die or a same die package.

### Example 27

An example apparatus may include circuitry for an FPGA. The circuitry may also include message logic to receive a sideband message from a sideband communication link coupled between the FPGA and an ASIC. The sideband message may include information that indicates the ASIC lacks programming or capability to fulfill a request to perform a function. The circuitry may also include search logic to search for and retrieve update information to update programming or capability of the FPGA to fulfill the request to perform the function if the FPGA lacks programming or capability to perform the function. The circuitry may also include update logic to send an indication via the sideband communication link to the ASIC to indicate the FPGA is programmed or capable to perform the function to fulfill the request.

### Example 28

The apparatus of example 27, the search logic to search for and retrieve update information includes the search logic to search an on-die database maintained at the FPGA, search a local database maintained at a computing platform hosting the ASIC and the FPGA or search a network database coupled with the computing platform through a network. The search logic may also retrieve the update information from the on-die database, the local database or the network database.

### Example 29

The apparatus of example 27, the search logic to search for and retrieve update information may include the search logic to request that an agent external to the FPGA search for and retrieve update information, the agent located at or executed by one or more processing elements for a computing platform hosting the ASIC and the FPGA.

### Example 30

The apparatus of example 27, the FPGA may be capable of being programmed via use of a Verilog programming language or a VHDL programming language.

### Example 31

The apparatus of example 27, the ASIC and the FPGA may be maintained or located on a same die or a same die package.

### Example 32

The apparatus of example 27, the function may include encrypting or decrypting data via use of a cryptographic algorithm specified in the request.

### Example 33

The apparatus of example 32, the information to indicate the ASIC is not programmed or capable to perform the function to fulfill the request may include the information to also indicate the cryptographic algorithm is unknown to the ASIC.

### Example 34

The apparatus of example 27, the function may include data packet routing via use of a given destination address.

### Example 35

The apparatus of example 34, the information to indicate the ASIC is not currently programmed to perform the function to fulfill the request may include the information to also indicate the given destination address is unknown to the ASIC.

### Example 36

The apparatus of example 27, the function may include implementation of a given scheduling rule to route one or more data packets to one or more destinations.

### Example 37

The apparatus of example 36, the information to indicate the ASIC is not programmed or capable to perform the function to fulfill the request may include the information to also indicate the given scheduling rule is unknown to the ASIC.

### Example 38

An example method may include receiving, at circuitry for an FPGA, a sideband message from a sideband communication link coupled between the FPGA and an ASIC. The sideband message may include information indicating the ASIC lacks programming or capability to fulfill a request to perform a function. The method may also include searching for and retrieving update information to update programming or capability of the FPGA to fulfill the request to perform the function. The method may also include sending an indication via the sideband communication link to the ASIC to indicate the FPGA is programmed or capable to perform the function to fulfill the request.

### Example 39

The method of example 38, searching for and retrieving update information may include searching an on-die database maintained at the FPGA, searching a local database maintained at a computing platform hosting the ASIC and the FPGA or searching a network database coupled with the computing platform through a network. searching for and retrieving update information may also include retrieving the update information from the on-die database, the local database or the network database.

### Example 40

The method of example 39, searching for and retrieving update information may include requesting that an agent external to the FPGA search for and retrieve update information, the agent located at or executed by one or more processing elements for a computing platform hosting the ASIC and the FPGA.

### Example 41

The method of example 38, the FPGA may be capable of being programmed using a Verilog programming language or a VHDL programming language.

### Example 42

The method of example 38, the ASIC and the FPGA may be maintained or located on a same die or a same die package.

### Example 43

The method of example 38, the function may include encrypting or decrypting data using a cryptographic algorithm specified in the request.

### Example 44

The method of example 43, the information indicating the ASIC is not programmed or capable to perform the function to fulfill the request may include the information also indicating the cryptographic algorithm is unknown to the ASIC.

### Example 45

The method of example 38, the function may include data packet routing using a given destination address.

### Example 46

The method of example 45, the information indicating the ASIC is not programmed or capable to perform the function to fulfill the request may include the information also indicating the given destination address is unknown to the ASIC.

### Example 47

The method of example 38, the function may include implementing a given scheduling rule to route one or more data packets to one or more destinations.

### Example 48

The method of example 47, the information indicating the ASIC is not programmed or capable to perform the function to fulfill the request may include the information also indicating the given scheduling rule is unknown to the ASIC.

### Example 49

An example at least one machine readable medium may include a plurality of instructions that in response to being executed by a system may cause the system to carry out a method according to any one of examples 38 to 48.

### Example 50

An example apparatus may include means for performing the methods of any one of examples 38 to 48.

### Example 51

An example at least one machine readable medium may include a plurality of instructions that in response to being executed by a system at an FPGA may cause the system to receive a sideband message from a sideband communication link coupled between the FPGA and an ASIC. The sideband message may include information that indicates the ASIC lacks programming or a capability to fulfill a request to perform a function. The instructions may also cause the system to search for and retrieve update information to update programming or capability of the FPGA to fulfill the request to perform the function if the FPGA lacks programming or capability to perform the function. The instructions may also cause the system to send an indication via the sideband communication link to the ASIC to indicate the FPGA is programmed or capable to perform the function to fulfill the request.

### Example 52

The at least one machine readable medium of example 51, the instructions may further cause the system to search an on-die database maintained at the FPGA, search a local database maintained at a computing platform hosting the ASIC and the FPGA or search a network database coupled with the computing platform through a network. The instructions may also cause the system to retrieve the update information from the on-die database, the local database or the network database.

### Example 53

The at least one machine readable medium of claim 51 may include the instructions to further cause the system to request that an agent external to the FPGA search for and retrieve update information, the agent located at or executed by one or more processing elements for a computing platform hosting the ASIC and the FPGA.

### Example 54

The at least one machine readable medium of example 51, the FPGA may be capable of being programmed via use of a Verilog programming language or a VHDL programming language.

### Example 55

The at least one machine readable medium of example 51, the ASIC and the FPGA may be maintained or located on a same die or a same die package.

### Example 56

The at least one machine readable medium of example 51, the function may include encrypting or decrypting data via use of a cryptographic algorithm specified in the request.

### Example 57

The at least one machine readable medium of example 56, the information to indicate the ASIC is not programmed or capable to perform the function to fulfill the request may include the information to also indicate the cryptographic algorithm is unknown to the ASIC.

### Example 58

The at least one machine readable medium of example 51, the function may include data packet routing via use of a given destination address.

### Example 59

The at least one machine readable medium of example 58, the information to indicate the ASIC is not programmed or capable to perform the function to fulfill the request may include the information to also indicate the given destination address is unknown to the ASIC.

### Example 60

The at least one machine readable medium of example 59, the function may include implementation of a given scheduling rule to route one or more data packets to one or more destinations.

### Example 61

The at least one machine readable medium of example 60, the information to indicate the ASIC is not programmed or capable to perform the function to fulfill the request may include the information to also indicate the given scheduling rule is unknown to the ASIC.

### Example 62

An example method may include receiving a request to perform a function for which an ASIC is not programmed or capable to perform. The method may also include sending a sideband message to an FPGA via a sideband communication link coupled between the ASIC and FPGA. The sideband message may include information indicating the ASIC is not programmed or capable to perform the function to fulfill the request. The method may also include searching for and retrieving update information to update programming or capability of the FPGA to fulfill the request to perform the function. The method may also include sending to the ASIC an indication via the sideband communication link to the ASIC that the FPGA is programmed or capable to perform the function to fulfill the request.

### Example 63

The method of example 62, the function may be encrypting or decrypting data via use of a cryptographic algorithm specified in the request.

### Example 64

The method of example 63, the information indicating the ASIC is not programmed or capable to perform the function to fulfill the request may include the information also indicating the cryptographic algorithm is unknown to the ASIC.

### Example 65

The method of example 63, the function may be data packet routing using a given destination address.

### Example 66

The method of example 65, the information indicating the ASIC is not programmed or capable to perform the function to fulfill the request may include the information also indicating the given destination address is unknown to the ASIC.

### Example 67

The method of example 63, the function may be implementing a given scheduling rule to route one or more data packets to one or more destinations.

### Example 68

The method of example 67, the information indicating the ASIC is not programmed or capable to perform the function to fulfill the request may include the information also indicating the given scheduling rule is unknown to the ASIC.

### Example 69

The method of example 63, the ASIC and the FPGA may be located or maintained on a same die or a same die package.

### Example 70

The method of example 63, searching for and retrieving update information may include searching an on-die database maintained at the FPGA, searching a local database maintained at a computing platform hosting the ASIC and the FPGA or searching a network database coupled with the computing platform through a network. Searching for and retrieving update information may also include retrieving the update information from the on-die database, the local database or the network database.

### Example 71

The method of example 71, searching for and retrieving update information may include requesting that an agent external to the FPGA search for and retrieve update information, the agent located at or executed by one or more processing elements for a computing platform hosting the ASIC and the FPGA.

### Example 72

The method of example 63, the FPGA may be capable of being programmed using an VHDL programming language.

### Example 73

An example at least one machine readable medium may include a plurality of instructions that in response to being executed by a system may cause the system to carry out a method according to any one of examples 63 to 72.

### Example 74

An example apparatus may include means for performing the methods of any one of examples 63 to 72.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry at an application specific integrated circuit (ASIC), the circuitry including:
request logic to receive a request to perform a function for which the ASIC is not programmed or capable to perform;
message logic to send a sideband message via a sideband communication link coupled between the ASIC and a field programmable gate array (FPGA), the sideband message to include information that indicates the ASIC is not programmed or capable to perform the function to fulfill the request; and
update logic to receive an indication via the sideband communication link to indicate the FPGA has been programmed or is capable to perform the function to fulfill the request.

2. The apparatus of claim 1, the function comprises encrypting or decrypting data via use of a cryptographic algorithm specified in the request.

3. The apparatus of claim 2, the information to indicate the ASIC is not programmed or capable to perform the function to fulfill the request comprises the information to also indicate the cryptographic algorithm is unknown to the ASIC.

4. The apparatus of claim 1, the function comprises data packet routing via use of a given destination address.

5. The apparatus of claim 4, the information to indicate the ASIC is not programmed or capable to perform the function to fulfill the request comprises the information to also indicate the given destination address is unknown to the ASIC.

6. The apparatus of claim 1, the function comprises implementation of a given scheduling rule to route one or more data packets to one or more destinations.

7. The apparatus of claim 6, the information to indicate the ASIC is not programmed or capable to perform the function to fulfill the request comprises the information to also indicate the given scheduling rule is unknown to the ASIC.

8. The apparatus of claim 1, comprising the ASIC and the FPGA located on a same die or a same die package.

9. A method comprising:
receiving, at circuitry for an application specific integrated circuit (ASIC), a request to perform a function for which the ASIC is not programmed or capable to perform;
sending a sideband message via a sideband communication link coupled between the ASIC and a field programmable gate array (FPGA), the sideband message including information indicating the ASIC is not programmed or capable to perform the function to fulfill the request; and
receiving an indication via the sideband communication link to indicate the FPGA has been programmed or is capable to perform the function to fulfill the request.

10. The method of claim 9, the function comprises encrypting or decrypting data using a cryptographic algorithm specified in the request.

11. The method of claim 10, the information indicating the ASIC is not programmed or capable to perform the function to fulfill the request includes the information also indicating the cryptographic algorithm is unknown to the ASIC.

12. An apparatus comprising:
circuitry for a field programmable gate array (FPGA), the circuitry including:
message logic to receive a sideband message from a sideband communication link coupled between the FPGA and an application specific integrated circuit (ASIC), the sideband message to include information that indicates the ASIC lacks programming or a capability to fulfill a request to perform a function;
search logic to search for and retrieve update information to update programming or capability of the FPGA to fulfill the request to perform the function if the FPGA lacks programming or capability to perform the function; and
update logic to send an indication via the sideband communication link to the ASIC to indicate the FPGA is programmed or capable to perform the function to fulfill the request.

13. The apparatus of claim 12, the search logic to search for and retrieve update information comprises the search logic to:
search an on-die database maintained at the FPGA, search a local database maintained at a computing platform hosting the ASIC and the FPGA or search a network database coupled with the computing platform through a network; and
retrieve the update information from the on-die database, the local database or the network database.

14. The apparatus of claim 12, the search logic to search for and retrieve update information comprises the search logic to:
request that an agent external to the FPGA search for and retrieve update information, the agent located at or executed by one or more processing elements for a computing platform hosting the ASIC and the FPGA.

15. The apparatus of claim 12, comprising the FPGA capable of being programmed via use of a Verilog programming language or a very high speed integrated circuit (VHSIC) hardware description language (VHDL) programming language.

16. The apparatus of claim 12, comprising the ASIC and the FPGA located on a same die or a same die package.

17. The apparatus of claim 12, the function comprises encrypting or decrypting data via use of a cryptographic algorithm specified in the request.

18. The apparatus of claim 17, the information to indicate the ASIC is not programmed or capable to perform the function to fulfill the request includes the information to also indicate the cryptographic algorithm is unknown to the ASIC.

19. A method comprising:
receiving, at circuitry for a field programmable gate array (FPGA), a sideband message from a sideband communication link coupled between the FPGA and an application specific integrated circuit (ASIC), the sideband message including information indicating the ASIC lacks programming or capability to fulfill a request to perform a function;
searching for and retrieving update information to update programming or capability of the FPGA to fulfill the request to perform the function; and
sending an indication via the sideband communication link to the ASIC to indicate the FPGA is programmed or capable to perform the function to fulfill the request.

20. The method of claim 19, searching for and retrieving update information comprises:
searching an on-die database maintained at the FPGA, searching a local database maintained at a computing platform hosting the ASIC and the FPGA or searching a network database coupled with the computing platform through a network; and
retrieving the update information from the on-die database, the local database or the network database.

21. The method of claim 19, searching for and retrieving update information comprises:
requesting that an agent external to the FPGA search for and retrieve update information, the agent located at or executed by one or more processing elements for a computing platform hosting the ASIC and the FPGA.

22. The method of claim 19, comprising the FPGA capable of being programmed using a Verilog programming language or a very high speed integrated circuit (VHSIC) hardware description language (VHDL) programming language.

23. The method of claim 19, comprising the ASIC and the FPGA located on a same die or a same die package.

24. The method of claim 19, the function comprises encrypting or decrypting data using a cryptographic algorithm specified in the request.

25. The method of claim 24, the information indicating the ASIC is not programmed or capable to perform the function to fulfill the request includes the information also indicating the cryptographic algorithm is unknown to the ASIC.
